(19) United States
(12) Patent Application Publication
(10) Pub. No.: US 2026/0363419 A1
(43) Pub. Date: Nov. 19, 2026

(54) HAIRDRESSING PRACTICE APPARATUS

(71) Applicant: Lijie Xiao, Yuzhou (CN)

(72) Inventor: Lijie Xiao, Yuzhou (CN)

(21) Appl. No.: 19/746,340

(22) Filed: Jul. 17, 2026

(30) Foreign Application Priority Data
Jun. 24, 2026 (CN) 202620945159.9

(51) Int. Cl. A45D 44/14; G09B 19/00

(52) U.S. Cl. CPC A45D 44/14; G09B 19/0076

(57) ABSTRACT

Provided is a hairdressing practice apparatus, which relates to the technical field of hairdressing practice. The hairdressing practice apparatus includes a mannequin head body and a scalp cover. The mannequin head body is connected to the scalp cover by using a connecting structure, and hair strands are fixedly connected to the scalp cover. The connecting structure includes a limiting groove portion and a limiting clamping rib, and the limiting clamping rib is fittingly clamped into the limiting groove portion, so as to implement assembly fit between the mannequin head body and the scalp cover.

### TECHNICAL FIELD

The present disclosure relates to the technical field of hairdressing practice, and in particular to a hairdressing practice apparatus.

### BACKGROUND

A hairdressing practice mannequin head is a common apparatus used by hairdressing trainees in hairdressing training institutions to cut hair, perm hair, and braid hair. The hair status of a real person is simulated based on simulated hair strands on the mannequin head, so as to meet repeated practical operation and practice requirements of novices. At present, the market demand is large, and the application scope is wide.

In the prior art, in most hairdressing practice mannequin heads, scalp is fixedly integrated with a mannequin head body. After the hair strands are worn out, the mannequin head has to be discarded as a whole, and the scalp cannot be replaced separately, resulting in severe material waste and high application costs.

### SUMMARY

The present disclosure aims to provide a hairdressing practice apparatus, so as to solve a problem in the prior art that a hairdressing practice apparatus is high in costs.

The present disclosure is implemented as follows. A hairdressing practice apparatus includes a mannequin head body and a scalp cover, where the mannequin head body is connected to the scalp cover by using a connecting structure, and hair strands are fixedly connected to the scalp cover; and the connecting structure includes a limiting groove portion and a limiting clamping rib, and the limiting clamping rib is fittingly clamped into the limiting groove portion, so as to implement assembly fit between the mannequin head body and the scalp cover.

Optionally, the limiting groove portion is disposed on the mannequin head body.

Optionally, the limiting clamping rib is disposed on the scalp cover.

Optionally, the limiting clamping rib includes an outer edge clamping rib disposed along an outer edge of the scalp cover, the limiting groove portion includes a profile groove provided on an outer surface of the mannequin head body, and the outer edge clamping rib is fitted and engaged with the profile groove.

Optionally, the outer periphery of the scalp cover is inwardly hemmed to form the outer edge clamping rib.

Optionally, the limiting clamping rib includes an annular clamping rib disposed at an inner top position of the scalp cover, the limiting groove portion includes a ring groove provided at the crown of a mannequin head, and the annular clamping rib is fitted and engaged with the ring groove.

Optionally, the connecting structure includes a hook-and-loop fastener assembly.

Optionally, the hook-and-loop fastener assembly includes a hook tape and a loop tape, and the hook tape and the loop tape are bonded to realize connection and fixation between the mannequin head body and the scalp cover.

Optionally, a concave first mounting groove is formed in the mannequin head body, and a concave second mounting groove is formed in the scalp cover; and the hook tape and the loop tape are respectively mounted on the first mounting groove and the second mounting groove;
the plurality of first mounting grooves are discretely arranged along an edge position of the scalp of the mannequin head body, and the first mounting grooves are disposed at edge and corner positions of the mannequin head body; and the plurality of second mounting grooves are discretely arranged along an edge position of the scalp cover, and the second mounting grooves are disposed at edge and corner positions of the scalp cover.

Optionally, the connecting structure includes a magnetic suction assembly.

Optionally, the magnetic suction assembly includes a first magnetic suction body and a second magnetic suction body, the first magnetic suction body is mounted on the mannequin head body, the second magnetic suction body is mounted on the scalp cover, and the first magnetic suction body and the second magnetic suction body are magnetically bonded to each other, so as to implement adsorption positioning between the mannequin head body and the scalp cover.

Optionally, a concave first magnetic suction groove is provided on the mannequin head body, and a concave second magnetic suction groove is provided on the scalp cover; and the first magnetic suction body is assembled on the first magnetic suction groove, and the second magnetic suction body is assembled on the second magnetic suction groove;
the plurality of first magnetic suction grooves are discretely arranged along an edge position of the mannequin head body, and the first magnetic suction grooves are disposed at edge and corner positions of the mannequin head body; and the plurality of second magnetic suction grooves are discretely arranged along an edge position of the scalp cover, and the second magnetic suction grooves are disposed at edge and corner positions of the scalp cover.

Optionally, a disassembly and assembly groove for dismantling the scalp cover is provided on the back of the mannequin head body;
a support surface is disposed at the bottom of the mannequin head body, and an insertion hole for inserting and assembling an external bracket is formed in the center of the support surface;
a protruding annular convex ring is disposed around an outer peripheral edge of the support surface;
the scalp cover includes an outer layer and an inner layer, the inner layer covers an inner surface of the scalp cover, and inner ends of the hair strands are arranged through the outer layer; and
the limiting groove portion is concave, and the groove width of the limiting groove portion gradually increases from top to bottom.

Compared with the prior art, according to the hairdressing practice apparatus provided in the present disclosure, by using a two-piece structure composed of the reusable mannequin head body and the removable scalp cover with hair strands, the limiting groove portion and the limiting clamping rib are clamped and assembled. After the hair strands are worn out, only the scalp cover needs to be replaced. The mannequin head body can be recycled for long-term use, which greatly reduces waste of raw materials and effectively reduces daily purchasing and application costs for training institutions. In addition, rapid disassembly, assembly and replacement of the scalp cover are achieved to improve practice efficiency.

### BRIEF DESCRIPTION OF THE DRAWINGS

FIG. 1 is a structure diagram of a hairdressing practice apparatus according to the present disclosure;

FIG. 2 is a structure diagram of a hairdressing practice apparatus according to the present disclosure;

FIG. 3 is a structure diagram of a mannequin head body according to the present disclosure;

FIG. 4 is a structure diagram of a scalp cover according to the present disclosure;

FIG. 5 is a structure diagram of a scalp cover according to the present disclosure;

FIG. 6 is a structure diagram of a hairdressing practice apparatus according to the present disclosure;

FIG. 7 is a diagrammatic cross-section of a scalp cover according to the present disclosure;

FIG. 8 is a structure diagram of a scalp cover according to the present disclosure; and

FIG. 9 is a structure diagram of a hairdressing practice apparatus according to the present disclosure.

### DETAILED DESCRIPTION OF THE EMBODIMENTS

In order to make the objectives, technical solutions and advantages of the present disclosure clearer, the present disclosure will be further described hereinbelow with reference to the drawings and embodiments thereof. It should be understood that, the embodiments described herein are only intended to illustrate but not to limit the present disclosure.

Implementation of the present disclosure is described in detail below in conjunction with specific embodiments.

Same or similar reference numerals in the drawings of the embodiments of the present disclosure correspond to same or similar parts. In the description of the present disclosure, it should be noted that the indicative direction or position relations of the terms such as “upper”, “lower”, “left”, and “right” are direction or position relations illustrated based on the drawings, just for facilitating the description of the present disclosure and simplifying the description, but not for indicating or hinting that the indicated device or element must be in a specific direction and is constructed and operated in the specific direction, and therefore, the terms for describing the position relations in the drawings are used for illustrative description only, but cannot be understood as the limitation of the present disclosure. For those skilled in the art, the specific meanings of the terms can be understood according to specific conditions.

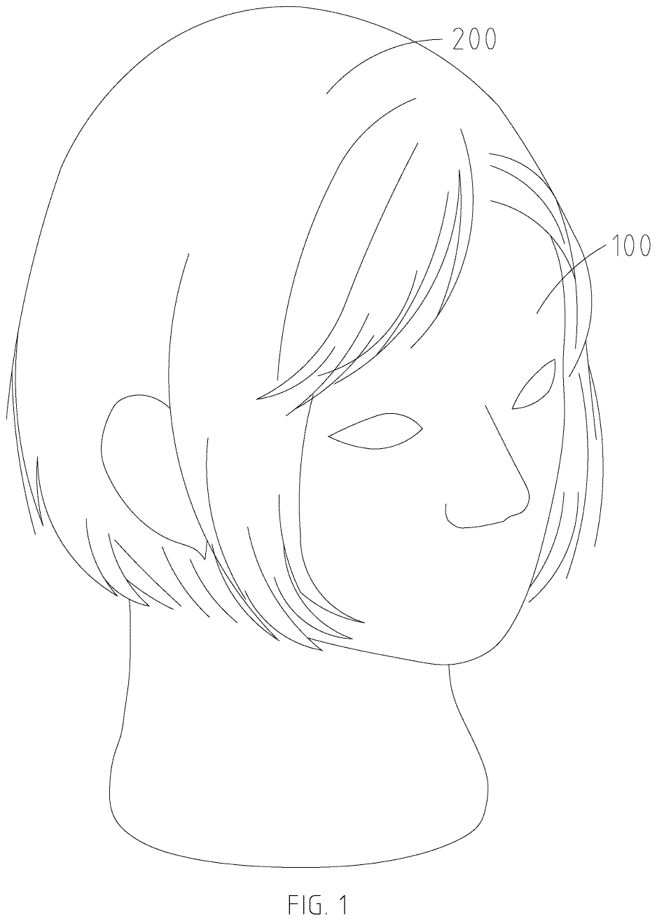

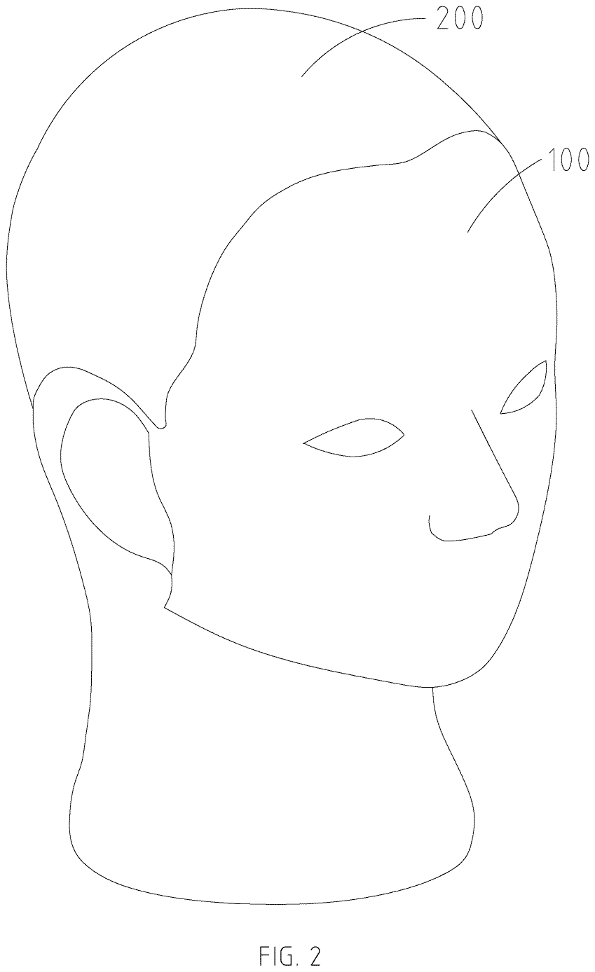

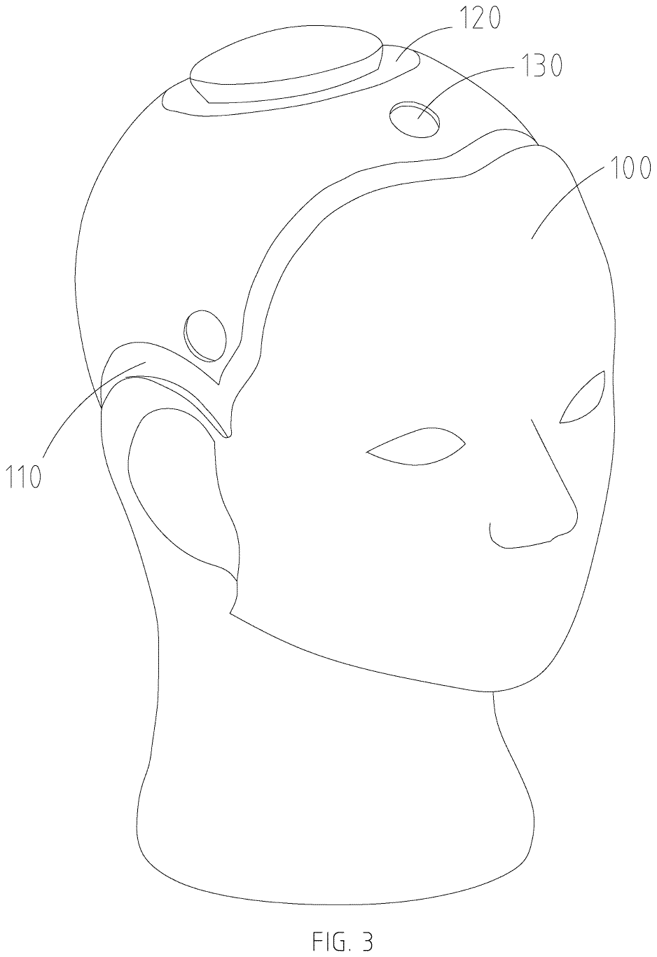

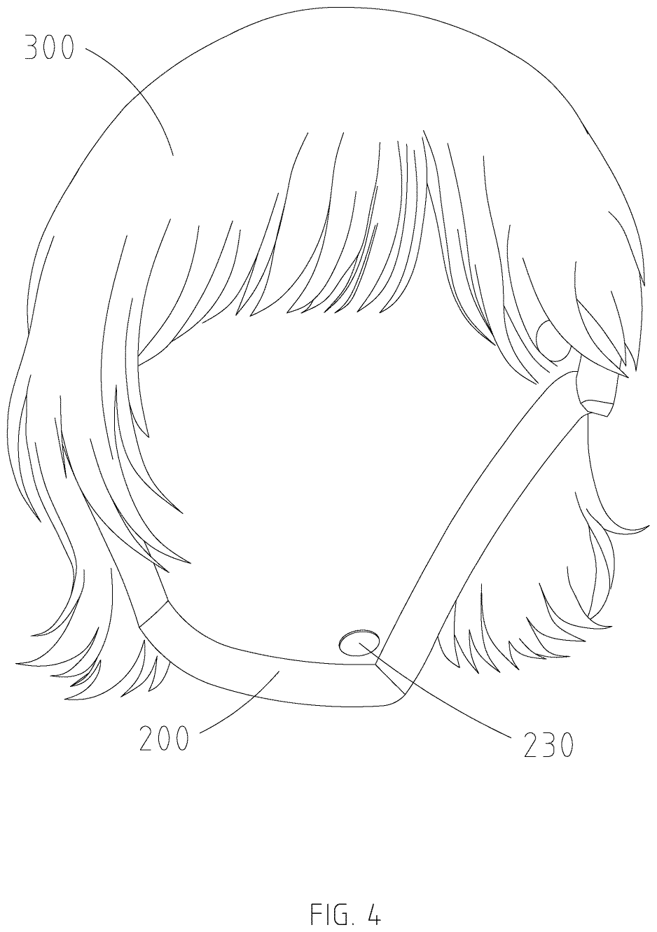

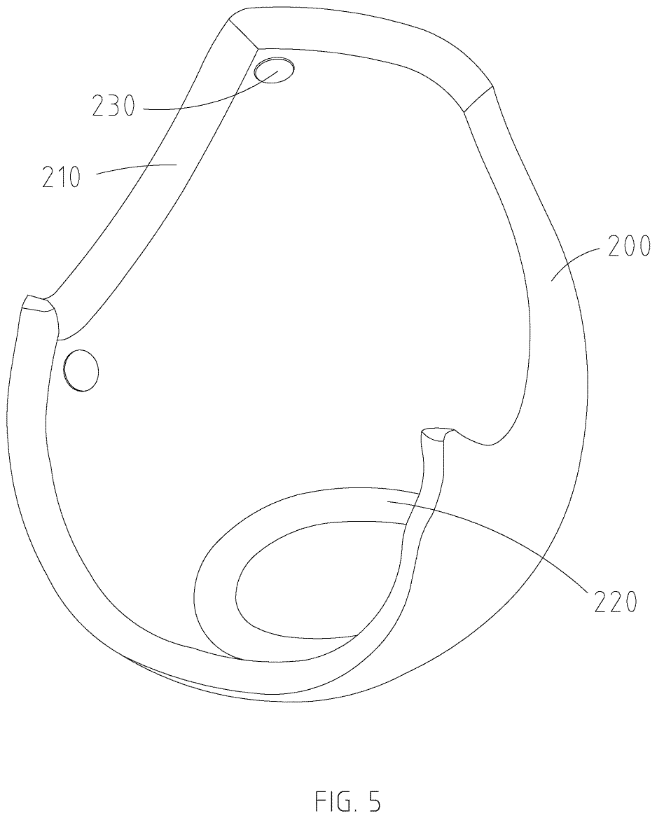

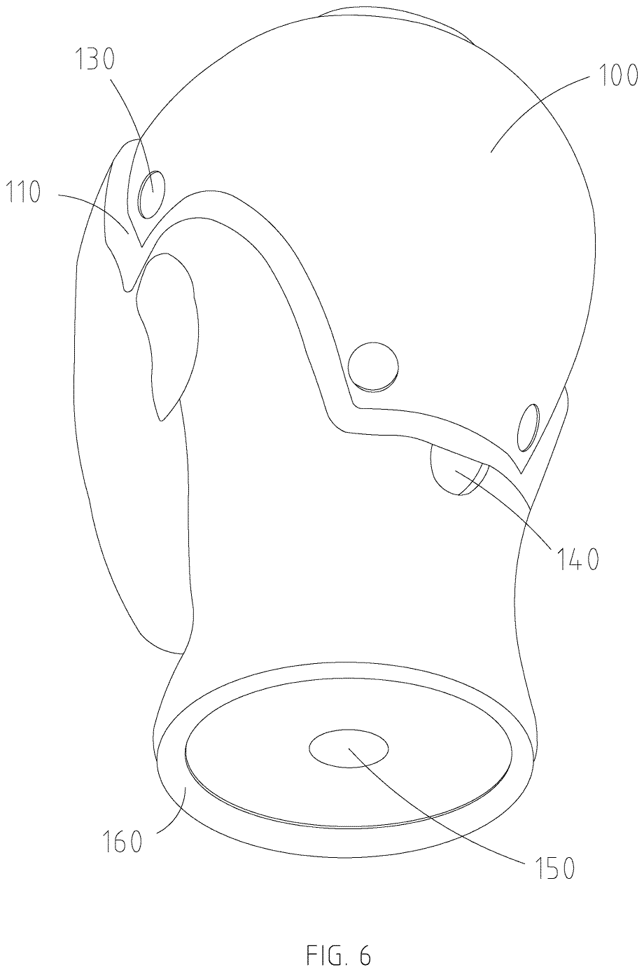

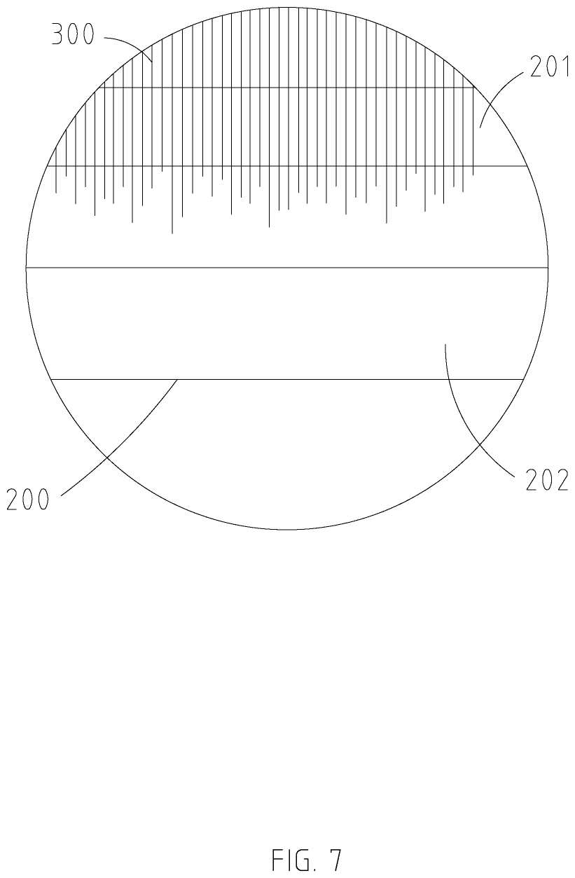

As shown in FIG. 1 to FIG. 9, a preferred embodiment of the present disclosure is provided.

A hairdressing practice apparatus provided in the present disclosure includes a mannequin head body 100 and a scalp cover 200, where the mannequin head body 100 is connected to the scalp cover 200 by using a connecting structure, and hair strands 300 are fixedly connected to the scalp cover 200; and the connecting structure includes a limiting groove portion and a limiting clamping rib, and the limiting clamping rib is fittingly clamped into the limiting groove portion, so as to implement assembly fit between the mannequin head body 100 and the scalp cover 200.

According to the provided hairdressing practice apparatus, by using a two-piece structure composed of the reusable mannequin head body 100 and the removable scalp cover 200 with hair strands 300, the limiting groove portion and the limiting clamping rib are clamped and assembled. After the hair strands 300 are worn out, only the scalp cover 200 needs to be replaced. The mannequin head body 100 can be recycled for long-term use, which greatly reduces waste of raw materials and effectively reduces daily purchasing and application costs for training institutions. In addition, rapid disassembly, assembly and replacement of the scalp cover 200 are achieved to improve practice efficiency.

The mannequin head body 100 is of a general-purpose human head imitation structure. The scalp cover 200 may be adapted to multiple human head imitation carriers of different specifications, including a hairdressing practice mannequin head body 100 and a humanoid robot head. In this way, a size and a profile of the scalp cover 200 are designed according to standards of a universal human head. By using the connecting structure, the scalp cover can be quickly assembled and fixed to outer surfaces of heads of different carriers, and general use of a hair strand structure on different devices is implemented. An application scenario of a product is greatly expanded. The apparatus not only can be used in traditional hairdressing teaching practice, but also can be directly adapted to a service robot and a simulation robot device that have a human head shape. A standardized removable hair strand solution is provided for robot appearance decoration and hair shape display, and there is no need to separately customize dedicated hair components for different carriers, thereby reducing development and production costs for multi-scenario applications.

The limiting groove portion is disposed on the mannequin head body 100. In this way, the limiting groove portion is integrated into the mannequin head body 100, and an integrally shaped structure is high in strength and convenient to machine, and is not prone to deformation and cracking for long-term and repeated disassembly and assembly.

The limiting clamping rib is disposed on the scalp cover 200. In this way, the limiting clamping rib is disposed on the scalp cover 200, and is integrally produced with the scalp cover 200, so that assembly alignment is simple and clamping positioning is accurate.

In this embodiment, the limiting clamping rib includes an outer edge clamping rib 210 disposed along an outer edge of the scalp cover 200, the limiting groove portion includes a profile groove 110 provided on an outer surface of the mannequin head body 100, and the outer edge clamping rib 210 is fitted and engaged with the profile groove 110. In this way, the outer edge clamping rib 210 and the profile groove 110 are engaged with each other, and are circumferentially limited along an outer periphery of a head, so as to prevent the scalp cover 200 from being offset or loosened.

Specifically, the outer periphery of the scalp cover 200 is inwardly hemmed to form the outer edge clamping rib 210. In this way, the outer edge clamping rib 210 and the profile groove 110 are engaged with each other, and are circumferentially limited along an outer periphery of a head, so as to prevent the scalp cover 200 from being offset or loosened.

In this embodiment, the limiting clamping rib includes an annular clamping rib 220 disposed at an inner top position of the scalp cover 200, the limiting groove portion includes a ring groove 120 provided at the crown of a mannequin head, and the annular clamping rib 220 is fitted and engaged with the ring groove 120. In this way, the annular clamping rib 220 and the ring groove 120 are additionally provided to implement secondary limitation from a top position, so as to prevent the top of the scalp cover 200 from warping or shifting and achieve improved fitting performance.

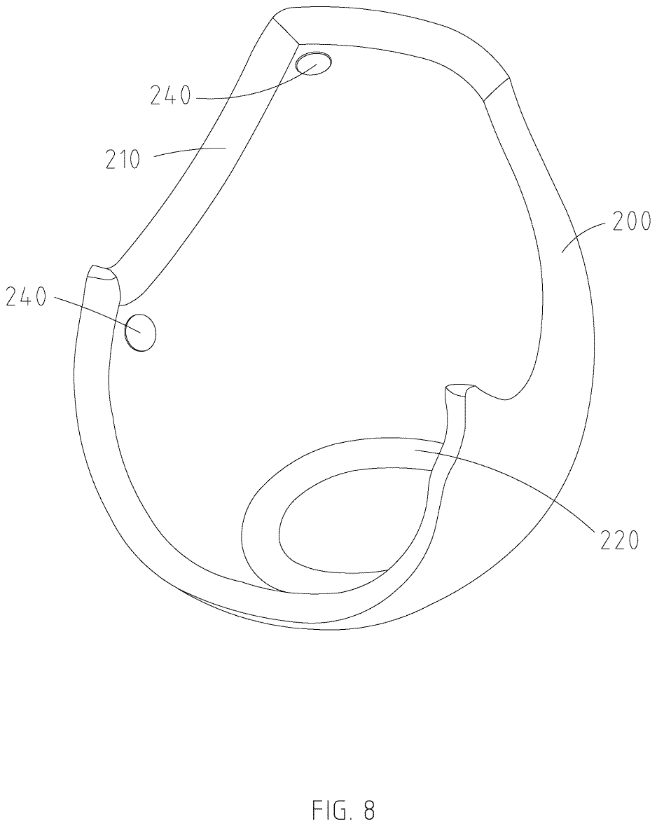

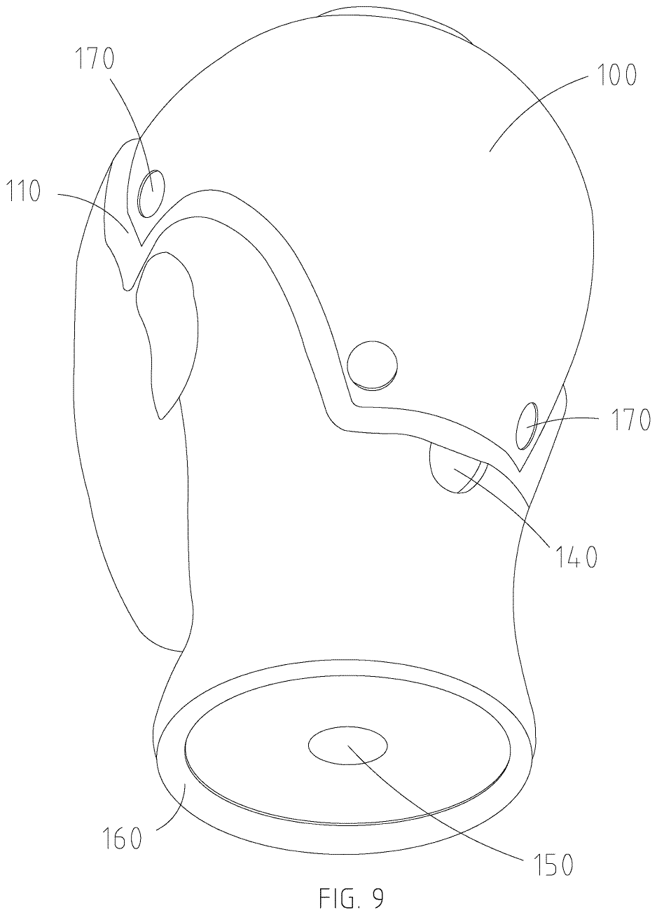

Referring to FIG. 8 and FIG. 9, the connecting structure includes a hook-and-loop fastener assembly. In this way, the structure is simple and reliable.

Specifically, the hook-and-loop fastener assembly includes a hook tape and a loop tape, and the hook tape and the loop tape are bonded to realize connection and fixation between the mannequin head body and the scalp cover. In this way, the structure is simple and reliable.

Specifically, a concave first mounting groove 170 is formed in the mannequin head body 100, and a concave second mounting groove 240 is formed in the scalp cover 200; and the hook tape and the loop tape are respectively mounted on the first mounting groove 170 and the second mounting groove 240. In this way, the hook-and-loop fastener assembly is limited by the mounting grooves to prevent falling off.

The hook tape is disposed on the first mounting groove 170, and the loop tape is mounted on the second mounting groove 240.

The loop tape is disposed on the first mounting groove 170, and the hook tape is mounted on the second mounting groove 240.

As a preferred embodiment, the plurality of first mounting grooves 170 are discretely arranged along an edge position of the scalp of the mannequin head body 100, and the first mounting grooves 170 are disposed at edge and corner positions of the mannequin head body 100; and the plurality of second mounting grooves 240 are discretely arranged along an edge position of the scalp cover 200, and the second mounting grooves 240 are disposed at edge and corner positions of the scalp cover 200. In this way, the hook-and-loop fastener assembly is disposed at edge and corner positions of the mannequin head, so that force-bearing points are scattered, adhesive force is evenly distributed, and uniform fastening performance is achieved.

As a preferred embodiment, the connecting structure further includes a magnetic suction assembly. In this way, the magnetic suction assembly is additionally provided for auxiliary fixation to realize dual limitation of clamping connection and magnetic suction, so that the scalp cover 200 is not prone to falling off when the hair strands 300 are pulled during daily hairdressing operations.

Specifically, the magnetic suction assembly includes a first magnetic suction body and a second magnetic suction body, the first magnetic suction body is mounted on the mannequin head body 100, the second magnetic suction body is mounted on the scalp cover 200, and the first magnetic suction body and the second magnetic suction body are magnetically bonded to each other, so as to implement adsorption positioning between the mannequin head body 100 and the scalp cover 200. In this way, the magnetic suction bodies are separately disposed at corresponding positions of the mannequin head body 100 and the scalp cover 200 to realize automatic adsorption and alignment during mold closing, which saves time and labor for assembly.

A concave first magnetic suction groove 130 is provided on the mannequin head body 100, and a concave second magnetic suction groove 230 is provided on the scalp cover 200; and the first magnetic suction body is assembled on the first magnetic suction groove 130, and the second magnetic suction body is assembled on the second magnetic suction groove 230. In this way, the magnetic suction grooves limit the magnetic suction bodies to prevent the magnetic suction bodies from falling off or shifting during use, thereby ensuring stable magnetic suction force.

The plurality of first magnetic suction grooves 130 are discretely arranged along an edge position of the mannequin head body 100, and the first magnetic suction grooves 130 are disposed at edge and corner positions of the mannequin head body 100; and the plurality of second magnetic suction grooves 230 are discretely arranged along an edge position of the scalp cover 200, and the second magnetic suction grooves 230 are disposed at edge and corner positions of the scalp cover 200. In this way, the magnetic suction grooves are arranged at edge and corner positions of the mannequin head, so that force-bearing points are scattered, adhesive force is evenly distributed, and uniform fastening performance is achieved.

In this embodiment, a disassembly and assembly groove 140 for dismantling the scalp cover 200 is provided on the back of the mannequin head body 100. In this way, the disassembly and assembly groove 140 may be used by a finger to extend into and pry up a corner of the scalp cover 200, so as to implement rapid disassembly and replacement and convenient and labor-saving disassembly and assembly.

In this embodiment, a support surface is disposed at the bottom of the mannequin head body 100, and an insertion hole 150 for inserting and assembling an external bracket is formed in the center of the support surface. In this way, the support surface at the bottom cooperates with the insertion hole 150 in the center, and can be quickly inserted into and fixed to a conventional hairdressing bracket on the market.

A protruding annular convex ring 160 is disposed around an outer peripheral edge of the support surface. In this way, the annular convex ring 160 on an outer ring of the support surface plays an anti-slip and limiting role, and the mannequin head body 100 mounted on the bracket is not prone to slipping and deflection.

As a preferred embodiment, the scalp cover 200 includes an outer layer 201 and an inner layer 202, the inner layer 202 covers an inner surface of the scalp cover 200, and inner ends of the hair strands 300 are arranged through the outer layer 201. In this way, the scalp cover 200 is of a double-layer structure. The inner layer 202 encloses and shields roots of the hair strands 300 to prevent pricking hands. The outer layer 201 allows the hair strands 300 to pass through for haircut practice, so that the scalp cover is durable and easy to clean.

The scalp cover 200 may be made of a silicone material, or may be made of a polyurethane material.

As a preferred embodiment, the limiting groove portion is concave, and the groove width of the limiting groove portion gradually increases from top to bottom. In this way, the limiting groove portion is of a gradually changing structure that is narrow at the top and wide at the bottom. During assembly, the clamping rib slides downwards from above to realize automatic guiding and clamping, resulting in smooth assembly and high assembly tolerance.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A hairdressing practice apparatus, comprising a mannequin head body and a scalp cover, wherein the mannequin head body is connected to the scalp cover by using a connecting structure, and hair strands are fixedly connected to the scalp cover; and the connecting structure comprises a limiting groove portion and a limiting clamping rib, and the limiting clamping rib is fittingly clamped into the limiting groove portion, so as to implement assembly fit between the mannequin head body and the scalp cover.

2. The hairdressing practice apparatus according to claim 1, wherein the limiting groove portion is disposed on the mannequin head body.

3. The hairdressing practice apparatus according to claim 1, wherein the limiting clamping rib is disposed on the scalp cover.

4. The hairdressing practice apparatus according to claim 1, wherein the limiting clamping rib comprises an outer edge clamping rib disposed along an outer edge of the scalp cover, the limiting groove portion comprises a profile groove provided on an outer surface of the mannequin head body, and the outer edge clamping rib is fitted and engaged with the profile groove.

5. The hairdressing practice apparatus according to claim 4, wherein the outer periphery of the scalp cover is inwardly hemmed to form the outer edge clamping rib.

6. The hairdressing practice apparatus according to claim 1, wherein the limiting clamping rib comprises an annular clamping rib disposed at an inner top position of the scalp cover, the limiting groove portion comprises a ring groove provided at the crown of a mannequin head, and the annular clamping rib is fitted and engaged with the ring groove.

7. The hairdressing practice apparatus according to claim 1, wherein the connecting structure comprises a hook-and-loop fastener assembly.

8. The hairdressing practice apparatus according to claim 7, wherein the hook-and-loop fastener assembly comprises a hook tape and a loop tape, and the hook tape and the loop tape are bonded to realize connection and fixation between the mannequin head body and the scalp cover.

9. The hairdressing practice apparatus according to claim 8, wherein a concave first mounting groove is formed in the mannequin head body, and a concave second mounting groove is formed in the scalp cover; and the hook tape and the loop tape are respectively mounted on the first mounting groove and the second mounting groove.

10. The hairdressing practice apparatus according to claim 9, wherein the plurality of first mounting grooves are discretely arranged along an edge position of the scalp of the mannequin head body, and the first mounting grooves are disposed at edge and corner positions of the mannequin head body; and the plurality of second mounting grooves are discretely arranged along an edge position of the scalp cover, and the second mounting grooves are disposed at edge and corner positions of the scalp cover.

11. The hairdressing practice apparatus according to claim 1, wherein the connecting structure further comprises a magnetic suction assembly.

12. The hairdressing practice apparatus according to claim 11, wherein the magnetic suction assembly comprises a first magnetic suction body and a second magnetic suction body, the first magnetic suction body is mounted on the mannequin head body, the second magnetic suction body is mounted on the scalp cover, and the first magnetic suction body and the second magnetic suction body are magnetically bonded to each other, so as to implement adsorption positioning between the mannequin head body and the scalp cover.

13. The hairdressing practice apparatus according to claim 12, wherein a concave first magnetic suction groove is provided on the mannequin head body, and a concave second magnetic suction groove is provided on the scalp cover; the first magnetic suction body is assembled on the first magnetic suction groove, and the second magnetic suction body is assembled on the second magnetic suction groove.

14. The hairdressing practice apparatus according to claim 13, wherein the plurality of first magnetic suction grooves are discretely arranged along an edge position of the mannequin head body, and the first magnetic suction grooves are disposed at edge and corner positions of the mannequin head body; and the plurality of second magnetic suction grooves are discretely arranged along an edge position of the scalp cover, and the second magnetic suction grooves are disposed at edge and corner positions of the scalp cover.

15. The hairdressing practice apparatus according to claim 1, wherein a disassembly and assembly groove for dismantling the scalp cover is provided on the back of the mannequin head body.

16. The hairdressing practice apparatus according to claim 1, wherein a support surface is disposed at the bottom of the mannequin head body, and an insertion hole for inserting and assembling an external bracket is formed in the center of the support surface.

17. The hairdressing practice apparatus according to claim 16, wherein a protruding annular convex ring is disposed around an outer peripheral edge of the support surface.

18. The hairdressing practice apparatus according to claim 1, wherein the scalp cover comprises an outer layer and an inner layer, the inner layer covers an inner surface of the scalp cover, and inner ends of the hair strands are arranged through the outer layer.

19. The hairdressing practice apparatus according to claim 1, wherein the limiting groove portion is concave, and the groove width of the limiting groove portion gradually increases from top to bottom.
